(19) United States
(12) Patent Application Publication
(10) Pub. No.: US 2009/0179431 A1
(43) Pub. Date: Jul. 16, 2009

(54) ZERO POLLUTION PROCESS AND FACILITY FOR GENERATING ELECTRICAL ENERGY

(76) Inventors: Eddie K. Wilson, SR., Ocean Springs, MS (US); Linda D. Studdard, Ocean Springs, MS (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/411,166

(22) Filed: Mar. 25, 2009

Related U.S. Application Data
(63) Continuation-in-part of application No. 11/617,412, filed on Dec. 28, 2006, now abandoned.

(51) Int. Cl. H02K 7/18

(52) U.S. Cl. 290/1 R

(57) ABSTRACT

A facility for generating electrical energy includes a pump jack having a walking beam provided with a head that oscillates upwardly and downwardly. In addition, the facility has a balance weight that moves upwardly and downwardly with the oscillations of the head on the walking beam. An intermediate assembly converts the oscillations into rotation of an output shaft, with the head elevating the balance weight as the head rises and the balance weight causing the head to descend. The output shaft is coupled to a drive shaft which drives an electrical generator.

### CROSS-REFERENCE TO RELATED APPLICATIONS

This application is a continuation-in-part of U.S. application Ser. No. 11/617,412 filed Dec. 28, 2006, which is incorporated herein by reference.

### STATEMENT REGARDING FEDERALLY SPONSORED RESEARCH

Not Applicable.

### BACKGROUND OF THE INVENTION

This invention relates in general to the production of electrical energy and more particularly to a facility and process for generating electrical energy.

Much of the electrical energy used by the United States and other countries, as well, derives from fossil fuels, such as coal, oil and natural gas. But as the finite reserves of these fuels are consumed, the fuels become more difficult and expensive to extract, thus increasing the cost of producing electrical energy. Moreover, their use introduces carbon dioxide and, in the case of some fuels, significant pollutants into the atmosphere, creating harmful conditions, such as smog and perhaps global warming. Other sources of electrical energy have their detractions as well. For example, hydroelectric projects usually include dams, which require huge capital expenditures and inundate land that could otherwise be put to productive purposes. Nuclear power plants are also costly and produce radioactive wastes, which must be disposed of safely. Wind-powered generators are unreliable, because they depend on winds that can vary in direction and magnitude, and furthermore they do not produce much power. Solar units are likewise deficient, because they require sun, which in many parts of the world shines infrequently, and furthermore such units produce only minimal energy.

The depletion of oil reserves has left many oil fields with unused pumping equipment. It simply remains idle, having no apparent useful purpose.

### BRIEF DESCRIPTION OF THE SEVERAL VIEWS OF THE DRAWINGS

FIG. 1 is a plan view of an electrical generating facility constructed in accordance with and embodying the present invention;

FIG. 2 is a sectional view of a pump jack forming part of the generating facility, it being taken along line 2-2 of FIG. 1; and

FIGS. 3A-3D are sequential views of the pump jack at several stages during a full cycle.

### DETAILED DESCRIPTION OF THE INVENTION

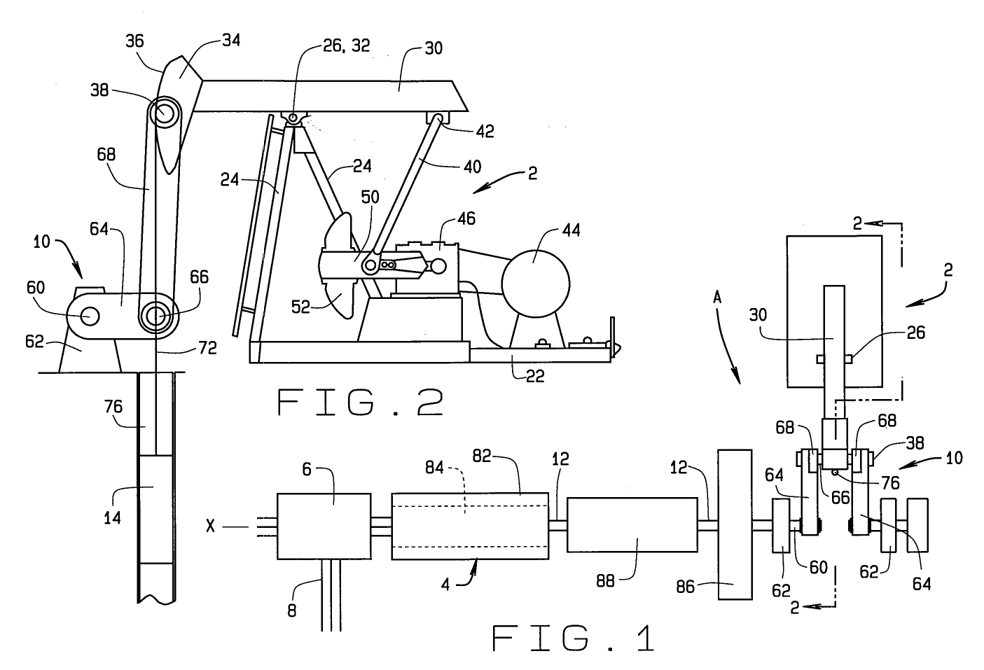

Referring to the drawings (FIG. 1), a facility A for producing electrical energy relies on a pump jack 2 of the type that is typically found throughout oil fields, but instead of pumping oil, the pump jack 2 together with other components serves to power an electrical generator 4 that actually produces the electrical energy. The energy so produced is directed to a control center 6 for voltage regulation and phase control and from there is distributed through electrical lines 8. The generator 4 rotates about a main axis X, and interposed between it and the pump jack 2 is an intermediate crank assembly 10 that converts the reciprocating motion of the pump jack 2 into rotary motion suitable for the generator 4. To this end, the crank assembly 10 rotates a drive shaft 12 that rotates about the main axis X and is coupled to the generator 4. In addition, the facility A has a balance weight 14 that acts on the main drive shaft 12 through the pump jack 2.

The pump jack 2 produces a reciprocating motion that in conventional applications imparts reciprocation to a pump rod that descends into a drill hole to extract oil from deep within the earth. In the facility A the crank assembly 10 converts the reciprocation produced by the pump jack 2 into rotary motion required to turn the generator 4. Any of several types of pump jacks 2 will suffice, the pump jack 2 that is disclosed being selected for purposes of illustration only. It takes the form of a Conventional Crank Balanced pumping unit of the type sold by Lufkin Industries of Lufkin, Tex. It could just as well be a Mark II Unitorque unit, or any one of several air-balanced units, or a Reverse-Mark unit, or a Churchill beam-balanced unit, a low profile unit, or trailer-mounted unit, all manufactured by Lufkin Industries as shown in catalogs of that company. The pump jack 2 may also be of other manufacturers, both domestic and foreign, to mention a few.

The pump jack 2 includes (FIG. 2) a frame 22 that rests on a foundation and has struts 24 that extend upwardly. At their upper ends the struts 24 support bearings 26 that are located along a transverse axis. The struts 24 carry a walking beam 30 having between its ends trunnions 32 that project laterally and are received in the bearings 26. The arrangement is such that the beam 30 can pivot in an oscillatory manner about the common axis of the bearings 26 and the trunnions 32. That axis lies parallel to the main axis X. At one end, the walking beam 30 is fitted with a head 34, often referred to as a “horsehead”, provided with an arcuate surface 36 that is convex and presented away from the trunnions 32. In contrast to the heads of conventional pump jacks, the head 34 of the pump jack 2 is fitted with a journal 38, the axis of which is parallel to the axis X. At its opposite end, the walking beam 30 is connected to connecting rods 40 at bearings 42.

The pump jack 2 also has a motor 44, which may be an electrical motor or an internal combustion engine, and nearby a gear-type speed reducer 46, both of which rest on the frame 22. They are connected by endless belts, or some other connecting device, such that the speed reducer 46 is powered at a reduced velocity by the motor 44. The speed reducer 46 drives crank arms 50 that rotate on it at an even lesser velocity. The crank arms 50 are coupled to the connecting rods 40 that are in turn coupled to the walking beam 30 at the bearings 42. Beyond the connecting rods 40 the crank arms 50 carry counterweights 52.

Thus, as the crank arms 50 rotate and carry the counterweights 52 around the axis of the speed reducer 46, the connecting rods 40 undergo a measure of translation, up and down, and impart an oscillatory motion to the walking beam 30. The head 34 at the opposite end of the walking beam 30 rises and falls. Actually, the motor 44 assists in bringing the counterweights 52 from bottom center to top center, but once the counterweights 52 move slightly beyond top dead center, the crank arms 50 and counterweights 52 fall freely back down to bottom center and through the rods 40 pivot the walking beam 30 such that the head 34 rises. Thereafter, the motor 44 and speed reducer 46 elevate the crank arms 50 and counterweights 52 to their top fall-over position.

The intermediate crank assembly 10 includes (FIGS. 2 & 3) a crank shaft 60 and bearing blocks 62 which confine the crank shaft 60 radially and axially, but leave it free to rotate. The crank shaft 60 aligns with the drive shaft 12 and is coupled to the drive shaft 12 such that the crank shaft 60 and drive shaft 12 rotate in unison about the axis X at the same velocity. In addition, the crank assembly 10 has two crank arms 64 that are attached to the crank shaft 60 such that they interrupt the shaft 60 and create a space between its two segments. Remote from the crank shaft 60 the crank arms 64 are fitted with a journal 66. In addition, the crank assembly 10 includes two pitman arms 68 that are spaced apart. Each at one of its ends is connected to the crank arms 64 at the journal 66 and at its other end is connected to the head 34 of the walking beam 30 at the journal 38 carried by the head 34.

The balance weight 14 occupies a pit 76 that lies below the crank assembly 10. It is connected to the head 34 on the walking beam 30 of the pump jack 2 through a cable 72 that extends over the convex arcuate surface 36 of the head 34. Thus, the balance weight 14 is suspended from the head 34 of the walking beam 30.

The crank shaft 60 of the crank assembly 10 is connected to the drive shaft 12 which in turn is connected to the generator 4. In this regard, the generator 4 includes (FIG. 1) a stator 82 and a rotor 84. The drive shaft 12 is coupled to the rotor 84 which it turns. The drive shaft 12 carries a flywheel 86 to carry the crank arms 64 beyond top and bottom dead centers and to effect a uniform velocity throughout each revolution of the crank shaft 60.

If the velocity of the crank shaft 60 does not match that the specified for the generator 4, a speed increaser 88 (FIG. 1) may be interposed in the drive shaft 12. The speed increaser 88 should be used as required.

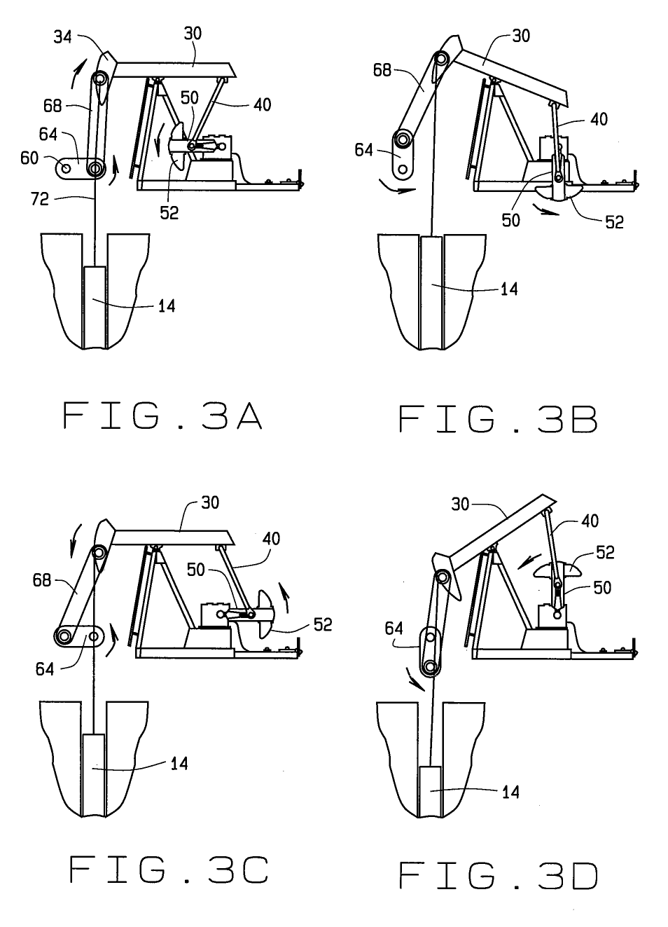

At the outset, before the generating facility A is set into operation, the balance weight 14 will most likely be at the very lowest point it can achieve in the pit 76 (FIG. 3D). When the balance weight 14 is so disposed, the crank arms 64 of the crank assembly 10 lie slightly beyond bottom dead center. On the other hand, the crank arms 50 on the speed reducer 46 are upright, placing the counterweights 52 at or slightly beyond top center. The counterweights 52 thereupon fall freely and rotate the walking beam 30 such that its head 34 rises, all without being impeded by the motor 44 (FIG. 3A). The head 34 draws the cable 72 upwardly and elevates the balance weight 14 in the pit 76 (FIG. 3A). The walking beam 30, acting through the pitman arms 68 also elevates the crank arms 64 of the crank assembly 10, and the crank arms 64 rotate the crank shaft 60 (FIG. 3A). Then the counterweights 52 move through bottom center (FIG. 3B), whereupon the connecting rods 40 begin to rise, and the head 34 of the walking beam 30 moves in the opposite direction downwardly. Indeed, the balance weight 14, acting through the cable 72, now pulls the head 34 of the walking beam 30 downwardly with considerable force (FIG. 3C). That force acts through the pitman arms 68 to drive the crank arms 64 of the crank assembly 10 downwardly away from top center (FIG. 3C), thus continuing the rotation of the crank shaft 60. The crank arms 64 continue to descend along with the descent of this balance weight 14 in the pit 76. The crank arms 64 reach bottom dead center (FIG. 3D). In the meantime, the motor 44, having again engaged the speed reducer 46, elevates the counterweights 52 on the pump jack 2 to top center (FIG. 3D). The cycle repeats and the crank shaft 60 continues to rotate. The crank shaft 60, in turn, rotates the drive shaft 12 in one direction. The flywheel 86 maintains the rotation of the drive shaft 12 at a uniform velocity in one direction.

The crank arms 64 of the crank assembly 10, of course, rotate the crank shaft 60, and the crank shaft 60 rotates the main drive shaft 12 which turns the rotor 84 of the generator 4. The generator 4 produces electrical energy which is distributed to an electrical grid or elsewhere through the control center 6 and the electrical lines 8.

The pump jack 2, the balance weight 14 and the crank assembly 10 form a drive unit and more than one drive unit may be coupled to the drive shaft 12 to power the generator 4. Indeed, crank shafts 60 of several units may be coupled end to end to rotate the drive shaft 12. Moreover, the pump jack 2 may be turned such that the axis of its bearings 26 and trunnions 32 are oriented 90° to the main axis X.

Another intermediate assembly, such as a sheave and cable, perhaps including a ratchet, may be substituted for the crank assembly 10.

1. A facility for generating electrical energy, said facility comprising:
a pump jack including a walking beam that oscillates and has a head that moves upwardly and downwardly during each oscillation;
a balance weight connected to the head of the walking beam;
an intermediate assembly connected to the head of the walking beam and having an output shaft that rotates in one direction in response to the oscillating movement of the head on the walking beam;
a drive shaft connected to the output shaft of the intermediate assembly; and
an electrical generator connected to and driven by the drive shaft.

2. A facility according to claim 1 wherein the intermediate assembly comprises:
the output shaft which functions as a crank shaft;
crank arms attached to the crank shaft; and
pitman arms connected to crank arms remote from the crank shaft and also connected to the head of the walking beam.

3. A facility according to claim 2 wherein the pump jack includes a motor and a speed reducer connected to the motor and having a counterweight that the motor rotates from a bottom position to a top position; wherein the counterweight falls from its top position to its bottom position; and wherein the weight of the counterweight elevates the head.

4. A facility according to claim 2 wherein the head on the walking beam has a convex surface, and the balance weight is connected to the head through a cable that passes over the convex surface.

5. A facility according to claims 4 wherein the cable passes between the crank arms of the crank assembly as those crank arms revolve.

6. A facility according to claim 4 wherein the cable passes between the pitman arms as the crank arms revolve.

7. A facility according to claim 6 wherein the crank arms remote from the crank shaft are connected to the head of the walking beam at a journal, and the pitman arms are connected to the crank arms at the journal.

8. A facility according to claim 4 wherein the balance weight is located below the crank assembly.

9. A process for generating electrical energy, said process comprising:
imparting rotation to a drive shaft with a pump jack and a balance weight; and
rotating an electrical generator with the drive shaft.

10. The process according to claim 2 wherein the pump jack has a walking beam provided with a head that oscillates upwardly and downwardly, and the balance weight moves upwardly and downwardly with the oscillations of the head.

11. The process according to claim 3 wherein the head of the pump jack and the balance weight rotate the drive shaft through a crank assembly which converts the oscillations of the head and balance weight into rotation of the drive shaft in one direction.
